(19) United States
(12) Patent Application Publication
(10) Pub. No.: US 2025/0173126 A1
(43) Pub. Date: May 29, 2025

(54) SPECIFICATION-COMPLIANT TECHNICAL SYSTEM BY MEANS OF FORMAL LANGUAGES WITH COMMON LOGIC

(71) Applicant: Robert Bosch GmbH, Stuttgart (DE)

(72) Inventors: Anne Von Vietinghoff, Renningen (DE); Thomas Heinz, Stuttgart (DE)

(21) Appl. No.: 18/961,622

(22) Filed: Nov. 27, 2024

(30) Foreign Application Priority Data
Nov. 29, 2023 (DE) 10 2023 211 901.3

(51) Int. Cl. G06F 8/30

(52) U.S. Cl. CPC G06F 8/31

(57) ABSTRACT

A computer-implemented method is for manufacturing a specification-compliant technical system, in particular a specification-compliant at least partially autonomous driving vehicle or a part thereof, including receiving time-dependent data from at least one test of the technical system, and translating the time-dependent data into a first specification in a first formal language at a first level of abstraction. The first formal language has a first semantics that is defined by a first interpretation mapping from the first formal language into a logic. The method further includes receiving a second specification in a second formal language at a second level of abstraction. The second formal language has a second semantics defined by a second interpretation mapping from the second formal language into the logic. The method also includes checking, based on a logical implication, how the first specification and the second specification relate to each other.

This application claims priority under 35 U.S.C. § 119 to patent application no. DE 10 2023 211 901.3, filed on Nov. 29, 2023 in Germany, the disclosure of which is incorporated herein by reference in its entirety.

### BACKGROUND

In complex, safety-critical technical systems such as autonomous systems (e.g. for autonomous driving, human-robot collaboration in industrial manufacturing, etc.), specifications are used for documentation, product development, validation (e.g. through test procedures) and are part of the required release argumentation.

In most cases, specifications are used in a top-down approach, i.e. the specified product (software and/or hardware) is developed from a specification. The development along the well-known V-model is an example established in the automotive industry for a refinement process in the sense of a development process from a specification to a product, but not necessarily a refinement of the specification itself. Even independently of the V-Modell, it may be necessary and/or useful to express a specification at different levels of abstraction. In particular, it may be necessary and/or useful to refine a specification at a higher level of abstraction to a specification at a lower level of abstraction. At the same time, it may be necessary and/or useful to abstract (i.e. generalize) a specification at a lower level of abstraction to a specification at a higher level of abstraction.

In industrial practice, specifications are usually described informally, e.g. in natural language, in requirements management tools such as IBM/DOORS. This requires a number of mostly manual steps to ensure the consistency of the product with the specification, without, however, ever being able to formally guarantee it. An automatic refinement and/or abstraction of the specification is not possible here.

The underlying problem of the disclosure is therefore to provide refinements and/or abstractions of one or more specifications in an automated way.

Formal specification languages such as Z, B and Event-B allow a step-by-step refinement of a specification in order to establish a provable relationship between specifications at different levels of abstraction using formal methods (semi-automatically with a theorem prover or automatically by means of model checking). However, the aforementioned languages are not suitable for representing specifications based on temporal logic, such as LTL (linear temporal logic). Furthermore, with the aforementioned formal specification languages, specifications must still be formulated manually at different levels of abstraction before, for example, it can be checked (automatically) whether these specifications represent correct refinements or abstractions.

The disclosure is therefore also based on the problem of automatically generating consistent specifications on at least one level of abstraction, in particular on different levels of abstraction. A specification hierarchy should thus be established.

The overriding problem underlying the disclosure is therefore that of manufacturing specification-compliant technical systems.

### SUMMARY

The problems mentioned above are solved by a framework proposed in this disclosure, in which specifications are or can be expressed by formal languages at different levels of abstraction. The formal languages can each have a semantics based on a common logic. The framework proposed here differs from known methods in that specifications can be written in different formal languages, which can be syntactically represented by a generic term structure and semantically fixed by the common logic (e.g. by a temporal logic). This common logic, usually just referred to as logic below, can be used to define refinements and abstractions, for example. Refinements or abstractions can be translations from one formal language at one level of abstraction to another formal language at a different level of abstraction. These can be computer-implemented and thus automated.

A first general aspect of the present disclosure relates to a computer-implemented method for manufacturing a specification-compliant technical system, in particular for manufacturing a specification-compliant partially autonomous driving vehicle or a part thereof. The method comprises receiving time-dependent data from at least one test of the technical system. The method further comprises translating the time-dependent data into a first specification in a first formal language at a first level of abstraction, wherein the first formal language has a first semantics defined by a first interpretation mapping from the first formal language into a logic. The logic may be decisive. The method further comprises receiving a second specification in a second formal language at a second level of abstraction, wherein the second formal language has a second semantics defined by a second interpretation mapping from the second formal language into the logic. The method may further comprise checking, based on a logical implication, how the first specification and the second specification relate to each other. For example, the method can check, based on the logical implication, to what extent the first specification covers the second specification and/or to what extent the second specification covers the first specification.

A second general aspect of the present disclosure relates to a computer system that is designed to carry out the computer-implemented method for manufacturing a specification-compliant technical system, in particular for manufacturing a specification-compliant at least partially autonomously driving vehicle or a part thereof, according to the first general aspect (or an embodiment thereof).

A third general aspect of the present disclosure relates to a computer program that is designed to carry out the computer-implemented method for manufacturing a specification-compliant technical system, in particular for manufacturing a specification-compliant at least partially autonomously driving vehicle or a part thereof, according to the first general aspect (or an embodiment thereof).

A fourth general aspect of the present disclosure relates to a computer-readable medium or signal that stores and/or contains the computer program according to the third general aspect (or an embodiment thereof).

A specification (e.g. the first specification and/or the second specification, i.e. any specification) may comprise or be a characterization of system behavior over time. System behavior can be the behavior of the (specification-compliant) technical system. A specification can include one or more requirements for system behavior over time. A specification can already be formulated in a formal language at a particular level of abstraction. Alternatively, the specification can initially be a natural language specification at a level of abstraction and then translated into a formal language (at this level of abstraction). Translating can include one or more refinements and/or one or more abstractions. Alternatively or additionally, translating may comprise translating time-dependent data from at least one test of the technical system.

A level of abstraction can be arranged in a partial order of levels of abstraction. The partial order of the levels of abstraction can comprise at least one lower and one higher level of abstraction. A level of abstraction and, if applicable, its arrangement in the partial order can be defined by expert knowledge. The closer a level of abstraction is to at least one test of the technical system, the deeper it can be.

A formal language can be an abstract language in which, unlike a natural language, the focus is (often) not on communication, but on the definition and application of formal systems in the narrower sense and logic in the broader, general sense. A formal language consists of a specific set of character strings, which can be referred to as words of the language and can be composed from a character set (also known as an alphabet). The alphabet does not necessarily have to be the alphabet known in linguistics (a, b, c . . . ). A formal language over an alphabet can be a subset of the Kleen shell of the alphabet. In addition to such a syntax, a semantics of the formal language can be defined.

Refinements and/or abstractions of one or more specifications form a core aspect of the framework presented here. After instantiation of the framework and formal proof of correctness, one or more refinements and/or one or more abstractions can be carried out automatically.

In addition to the top-down approach (with regard to the levels of abstraction), the framework enables an automated bottom-up approach (also with regard to the levels of abstraction), i.e. it can generalize observed system behavior, e.g. in the form of measurements in the field, to abstract behavior. Such a set of abstract behavior may be understood as a specification, as in the method according to the first general aspect (or an embodiment thereof). A special case of this generalization can be the abstract scenario identification of driving data. Another example in this context can be the reconstruction of driving scenarios in simulation environments.

The framework proposed herein, in particular the method according to the first general aspect (or an embodiment thereof) enables consistent formulation of specifications at different levels of abstraction. This makes it easier for the specification developer to quickly and correctly formulate requirements at a particular level of abstraction. The automatic and consistent translation to other levels of abstraction provides feedback to the specification developer, which facilitates the validation of the formulated specifications.

The manually formulated and automatically generated specifications can be used to create one or more quantitative monitors, for example, which can be used to automatically generate tests using optimization procedures. This enables, for example, the (non-formal) verification of desired properties in the product.

The use of a (generally) separate formal language for each level of abstraction, or even several formal languages at one level of abstraction, is based on a generic term structure. Each language can be understood as a DSL (Domain-specific Language), which makes the core of the respective level of abstraction effectively formulable. The framework for abstraction and/or refinement can reduce the effort required to ensure consistency between specification and product/implementation. For example, corresponding parts of a software can be generated directly from the specification at a suitable level of abstraction, e.g. software for behavior planners of automated vehicles from the specification of the behavior of the at least partially automated vehicle or monitoring monitors that detect potentially problematic near-future situations. The framework for abstraction and/or refinement and in particular the method according to the first general aspect (or an embodiment thereof) also allows the representation of recorded field data (e.g. driving situation data) in the form of “formulas” at different levels of abstraction that are comprehensible to the specification developer. On the one hand, this allows extensive amounts of time-dependent data from at least one test of the technical system—also referred to as field data (e.g. driving data)—to be assigned to a plurality of equivalence classes with regard to different levels of abstraction. On the other hand, the data can be more easily interpreted in terms of their representativeness. This makes it possible to identify missing specifications. In this context, the following cases can be distinguished, for example: specifications that are included in the data but have not yet been formulated in the specifications, unfulfilled specifications (specifications formulated in the form of “if-then rules” for which the “then” is violated by the data), and incomplete field data (specifications in the form of “if-then rules” for which the “if” is not covered by any data).

These properties allow a device for testing complex technical systems (e.g., an at least partially autonomously driving vehicle or a part thereof) to be designed with the aim of efficiently using test efforts (e.g., test drives) with regard to covering a given set of specifications/requirements. For example, an iterative process can be used to first determine the smallest possible number of tests of the technical system (e.g. driving maneuvers) that cover all manually formulated and automatically generated specifications at different levels of abstraction. For example, an initial set of one or more tests of the technical system can be constructed using a suitable DOE (Design of Experiments) procedure. For each test, the result (i.e. a measurement and/or simulation) can be automatically expressed in all levels of abstraction by abstraction. If such an abstraction of the measurement—in the process according to the first general aspect (or an embodiment thereof), for example, the first specification—is consistent with a specification to be covered—in the process according to the first general aspect (or an embodiment thereof), for example, the second specification—the abstraction of the measurement fulfills the specification. The framework for abstraction and/or refinement thus allows the automatic verification of multiple specifications at different levels of abstraction using a single test. If the abstraction of the test fulfills a specification, in the simplest case it can be considered as covered by the test. Since the test is expressed by abstraction in the formal language of the specification—in the procedure according to the first general aspect (or an embodiment of it) in the first formal language—there is also the possibility of a more precise consideration: for example, it can be determined whether the abstraction completely or only partially covers the specification. In the latter case, at least one further test of the technical system can be automatically generated if required or desired, for example by refining the part of the specification not covered by the abstraction of the test. If the abstraction of the test is inconsistent with the specification, it is possible to distinguish and determine whether it is actually an error in the product, the specification is faulty, or whether the abstraction of the test is causing an apparent inconsistency.

The method proposed in this disclosure, according to the first aspect (or an embodiment of it), enables the development of specifications, for example, in an iterative process that can benefit from the formal refinement and abstraction relationships. In particular, observations of the specified technical system, e.g. in the form of field data (the time-dependent data), can contribute to this. When put into a suitable form, this field data can be understood as an element of a refined specification language (language close L in the partial order, i.e. at a lower level of abstraction). Through abstraction, the representation can be automatically translated into a plurality of formal languages that are achievable in the partial order through abstraction. Each of these data specifications d can be linked to a specification s that is either manually created or automatically generated through refinement or abstraction. In doing so, checking how the first specification and the second specification relate to each other can, for example, lead to the following results:

For example, if the second specification s (that is, the predefined specification) covers the first specification d (that is, the data specification), that is, if I(d) [symbol] I(s) applies, the abstraction of the data is covered by the predefined specification. If this does not apply, the specification developer can use I(d)∧¬I(s), for example, to check whether an extension of the given specification is necessary or whether this is deliberately excluded.

Alternatively or additionally, if the first specification d (i.e. the data specification) covers the second specification s (i.e. the given specification), i.e. applies I(s) [symbol] I(d), the given specification is covered by the abstraction of the data. If this does not apply, then one or more further tests of the technical system can be found by automatically refining I(s)∧¬I(d) in the direction of a formal language close to L in the partial order, in order to generate missing data.

The method according to the first general aspect (or an embodiment thereof) can comprise performing this one or more further tests.

### BRIEF DESCRIPTION OF THE DRAWINGS

FIG. 1a schematically illustrates exemplary embodiments of a computer-implemented method for manufacturing a specification-compliant technical system.

FIG. 1b schematically illustrates exemplary embodiments of a computer-implemented method for manufacturing a specification-compliant technical system, wherein time-dependent data from at least one test of the technical system is translated into a third specification (as an intermediate step) and then into a first specification.

FIG. 1c schematically illustrates exemplary embodiments of a computer-implemented method for manufacturing a specification-compliant technical system, wherein a fourth specification (as an intermediate step) is translated into a second specification.

FIG. 1d schematically illustrates exemplary embodiments of a computer-implemented method for manufacturing a specification-compliant technical system, wherein time-dependent data from at least one test of the technical system is translated into a third specification (as an intermediate step) and then into a first specification and wherein a fourth specification (as intermediate step) is translated into a second specification.

FIG. 2 schematically illustrates exemplary levels of abstraction for at least the time-dependent data, for the first specification and for the second specification.

FIG. 3 schematically illustrates at least a first interpretation map, which maps the first formal language into the logic, and a second interpretation map, which maps the second formal language into the (same) logic.

FIG. 4 schematically illustrates a driving scenario at an intersection with an at least partially autonomously driving vehicle and another road user.

FIG. 5 schematically illustrates a plurality of formal languages, sometimes at different levels of abstraction, as well as refinements between the formal languages.

FIG. 6 shows exemplary kinematic variables over a prediction time.

FIG. 7 shows an example of a transformation of a position interval from a local coordinate system to a global coordinate system.

FIG. 8 shows an exemplary transformation for a straight road from the local to the global coordinate system

### DETAILED DESCRIPTION

The advantages described are achieved by providing different formal languages based on a generic term structure, which allow specifications to be expressed at different levels of abstraction. The formal languages are based on a common logic that defines the semantics, i.e. the meaning of the formal languages. Specifications of a formal language can be automatically translated into consistent specifications in other formal languages. A distinction is made between two directions: Abstraction and refinement.

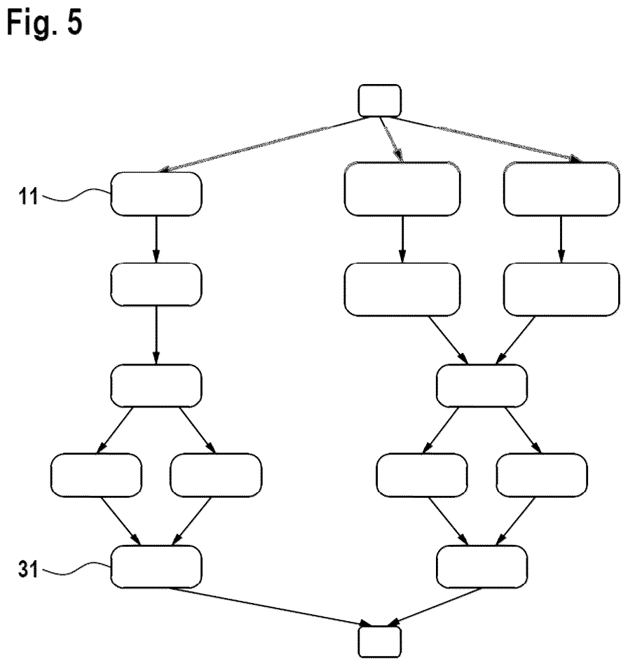

FIG. 5 exemplarily and schematically shows a plurality of levels of abstraction (rounded boxes), wherein an level of abstraction is the higher the more up in FIG. 5 it is represented with regard to its degree of abstraction. At least one formal language may be defined per level of abstraction. An exemplary assignment of the first formal language 11 and the third formal language 31 is also shown. Thus, FIG. 5 for example, formal languages for the specification of relevant traffic situations and scenarios (predefined sequence of traffic situations) in the context of at least partially autonomous driving. The formal languages can form a partial order in terms of refinement. For a relationship Sⱼ→Sₖ in this partial order, each valid specification in the language Sⱼ can be converted into a corresponding refined specification in the language Sₖ. If specifications are transferred in the opposite direction to the arrow, this is referred to as an abstraction. It should be noted that an abstraction does not necessarily exist for every refinement and vice versa.

The framework for abstraction and/or refinement can be described by a plurality of formal languages S₁, . . . , Sₙ, (at least two formal languages), whereby an abstraction or refinement relationship can exist between two formal languages Sⱼ, Sₖ. A formal language Sⱼ can be understood syntactically as a set of terms, which is created by the following simple rule (e.g. in the Backus-Naur form):

$$Term ∷ = Symbol \vert Term ( Term , … , Term )$$

The set of permissible terms of a formal language can be restricted syntactically or by a type system. The syntactic structure can be defined, for example, by frameworks such as xtext, metaprogramming languages such as Racket or theorem provers such as Lean 4.

A valid term t∈Sⱼ of a formal languageSⱼ—also called a well-formed term—receives its meaning through an interpretation mapping Iⱼ. In order to be able to define such interpretation mappings, a semantic basis is first defined for all languages S₁, . . . , Sₙ of the plurality of formal languages. One manifestation of this semantics is the definition of a specific logic L. This logic L is also referred to as common logic. For example, a temporal logic such as a linear temporal logic (LTL) or a signal temporal logic can be considered as logic L. Alternatively or additionally, temporal logic can be combined with an arithmetic theory such as linear, real arithmetic or real polynomial arithmetic. In this way, changes in geometric objects can be described over time, for example. Syntactically, logic can also be understood as a set of terms.

For a (in particular any) formal language Sⱼ an interpretation mapping Iⱼ:Sⱼ→L from the formal language Sⱼ into the logic L can be defined inductively via the term structure of Sⱼ, which determines the semantics of the language through the logic L. The interpretation mapping Iⱼ therefore translates each term s∈Sⱼ into a term I=Iⱼ(s)∈L of logic L. The term l=Iⱼ(s)∈L can be described as an interpretation of s∈Sⱼ. A term of logic also represents a statement. For the automation capability of the abstraction/refinement framework, it is advantageous if the logic L is decidable. In this case, there is always an algorithm which, given two terms (also: statements) l₁, l₂∈L decides whether the statement l₁ logically implies the statement l₂, i.e. whether the logical implication l₁ [symbol] l₂ applies. A statement l₁ of the logic L can logically imply the statement l₂ of the logic L precisely then, i.e. h l₁ [symbol] l₂ (wherein [symbol] the logical implication is) if the statement l₁ can be formally derived from the statement l₂, e.g. by means of a deduction system consisting of axioms and derivation rules of the logic L. The character [symbol] is not a symbol of logic 50, L and in particular not a binary operator of logic 50, L. In particular, the character [symbol] is not an implication ⇒ (or →) within the logic 50, L. Instead, the character [symbol] relates statements of logic 50, L to each other. In other words, the overall statement l₁ [symbol] l₂ is not part of the logic 50, L, but stands outside it. The logical implication ( [symbol] ) can be a semantic inference and/or syntactic inference (also: derivation relation). In the context of temporal logic—in particular LTL supplemented by a decidable arithmetic theory-such algorithms exist through reduction to a decision problem in automata theory. If the logic cannot be decided, the framework can still be used to the extent that an algorithm as described above exists for the implication to be calculated. Formal languages with interpretation mappings into the logic L, 50 are illustrated schematically in FIG. 3.

A formal language Sₖ can refine a formal language Sⱼ by means of a mapping R_{j,k}:Sⱼ→Sₖ (notation: Sⱼ [symbol] Sₖ) exactly when ∀s∈Sⱼ:Iₖ (R_{j,k}(s)) [symbol] (s). The mapping R_{j,k} is a refinement. Thus, a refinement from one formal language (Sⱼ) to another formal language (Sₖ) can be a mapping (R_{j,k}) from one formal (Sⱼ) language to the other formal language (Sₖ), wherein a concatenation of the interpretation mapping (Iₖ) of the other formal language (Sₖ) and the mapping (R_{j,k}) on each term (s) of the one formal language (Sⱼ) respectively implies the interpretation (Iⱼ(s)) on the term (s).

A formal language Sⱼ can abstract a formal language Sₖ by means of a mapping A_{k,j}:Sₖ→S₁ (notation: Sⱼ [symbol] Sₖ) exactly when ∀s∈Sₖ:Iₖ(s) [symbol] Iⱼ(A_{k,j}(s)). The mapping A_{k,j} is an abstraction. Thus, an abstraction from one formal language (Sₖ) to another formal language (Sⱼ) can be a mapping (A_{k,j}) from one formal (Sₖ) language to the other formal language (Sⱼ), wherein a concatenation of the interpretation mapping (Iⱼ) of the other formal language (Sⱼ) and the mapping (A_{k,j}) on each term (s) of the one formal language (Sₖ) respectively implies the interpretation (Iₖ(s)) on the term (s).

The languages S₁, . . . , Sₙ can each form a partial order with regard to the relation [symbol] (refinement) or [symbol] (abstraction). If there is a relation Sⱼ [symbol] Sₖ for each relation Sⱼ [symbol] Sₖ and vice versa, both partial orders are identical. Both refinement and abstraction are transitive, i.e. (Sⱼ [symbol] Sₖ∧Sₖ [symbol] Sₜ)⇒Sⱼ [symbol] Sₗ and (Sⱼ [symbol] Sₖ∧Sₖ [symbol] Sₗ)⇒Sⱼ [symbol] Sₗ. This allows the automatic refinement or abstraction of a term across several languages (by concatenating several refinements or abstractions).

The correctness of each refinement or abstraction relation can be shown formally by induction via the respective term structure, e.g. with the help of a theorem prover. The fact that the logical implication l₁ [symbol] l₂ can be decided automatically can be exploited.

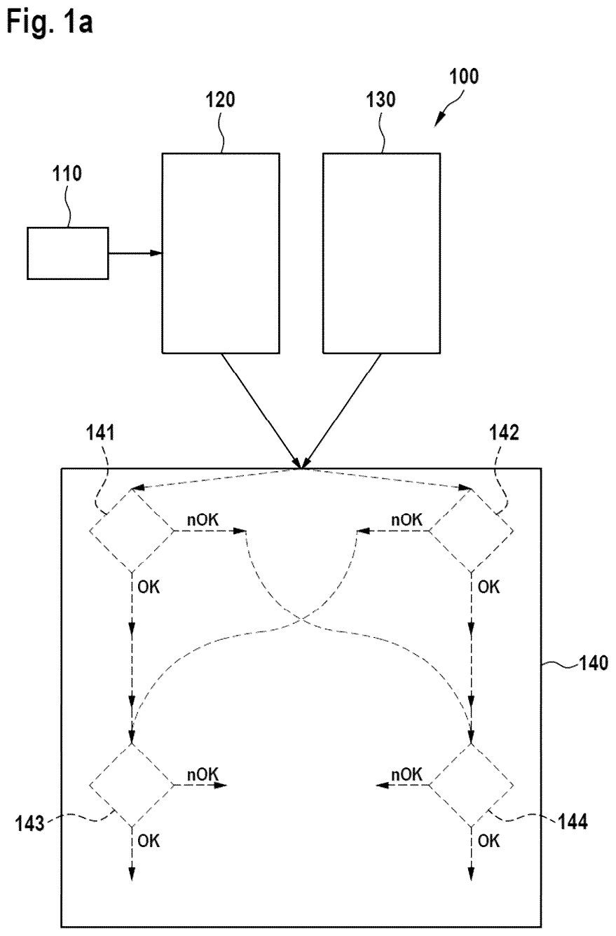

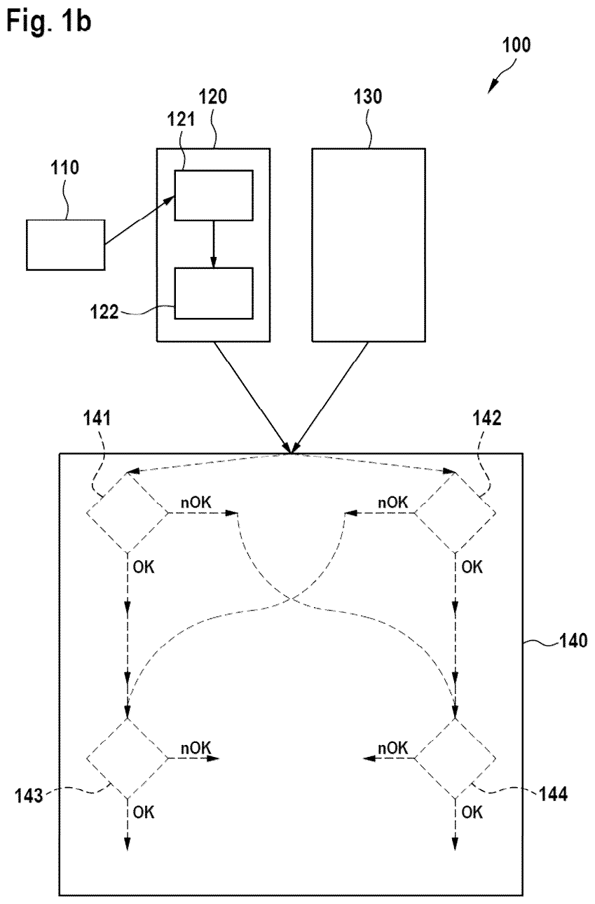

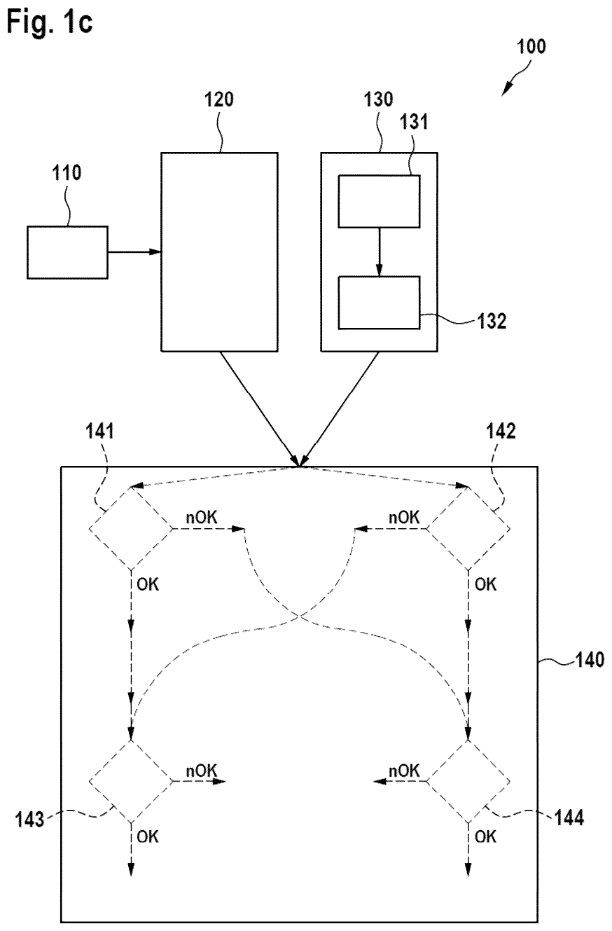

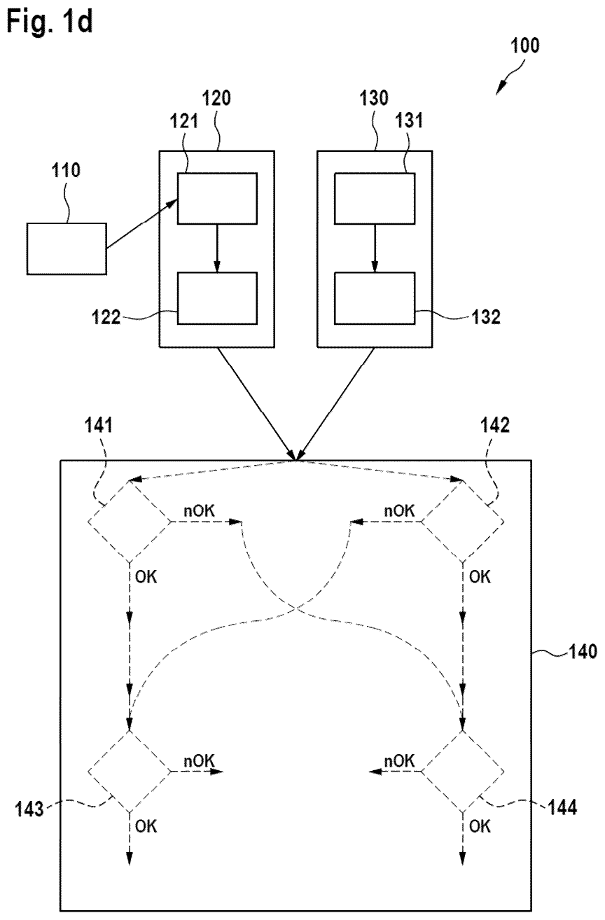

Disclosed now is a computer-implemented method 100, schematically illustrated in FIGS. 1a-d for manufacturing a specification-compliant technical system. The computer-implemented method 100 may, in particular, be a method for manufacturing a specification-compliant, at least partially autonomously driving vehicle, or a part thereof. The technical system can be a cyber-physical system. The technical system can be an at least partially autonomous system. For example, the technical system may be a at least partially autonomously driving vehicle or a part thereof.

The method 100 comprises receiving 110 time-dependent data 1 from at least one test of the technical system. The time-dependent data 1 can comprise or be, for example, measurement and/or simulation data.

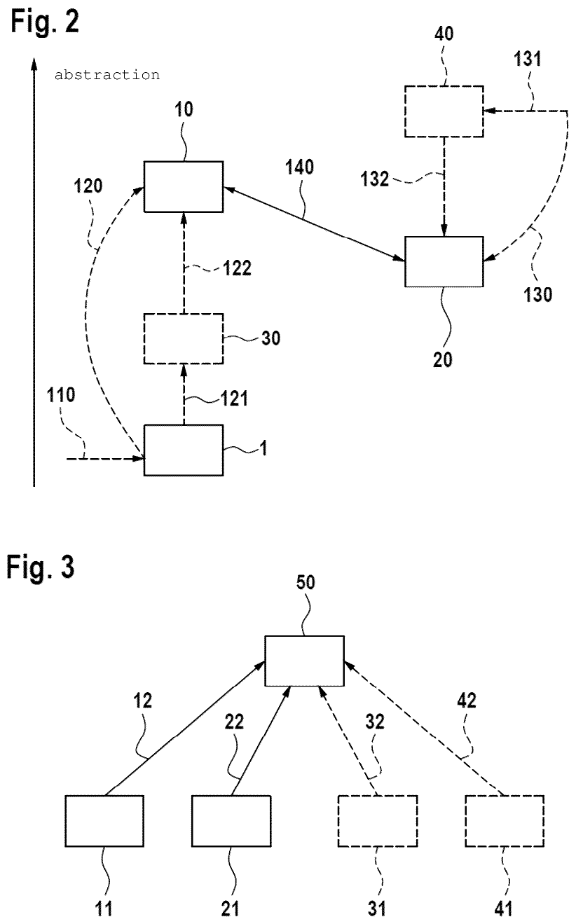

The method 100 further comprises translating 120 the time-dependent data 1 into a first specification 10 in a first formal language 11 at a first level of abstraction, wherein the first formal language 11 has a first semantics, which is defined by a first interpretation mapping 12 from the first formal language 11 into a logic 50, wherein preferably the logic 50 is decidable. The first specification 10 can be described as a data specification. The first level of abstraction can, for example, be a lower or the lowest level of abstraction (with regard to the partial order of abstraction). On the other hand, the first level of abstraction can also be an upper or the highest level of abstraction (with regard to the partial order of abstraction). FIG. 2 schematically shows an assignment in which the first level of abstraction does not lie on the lowest two levels of abstraction. The attribute “first” in “first level of abstraction” does not necessarily denote a first element in a partial order of abstraction and/or refinement. In other words, each level of abstraction of such a partial order may be a first level of abstraction as defined in step 120.

The method 100 further comprises receiving 130 a second specification 20 in a second formal language 21 at a second level of abstraction, wherein the second formal language 21 has a second semantics defined by a second interpretation mapping 22 from the second formal language 21 into the logic 50. The second specification 20 can be a predefined specification. A specification can be predefined if it is given at the latest at the time of execution of the (respective) process step in which it is processed (here, step 140) and, in particular, is available for the (respective) process step. Thus, in contrast to the schematic illustration in FIG. 1a-d step 130 could also take place before step 120 or with or before step 110. In particular, the second specification 20 need not have been translated from the time-dependent data 1 from step 110. The second level of abstraction can, for example, be an upper or the highest level of abstraction (with regard to the partial order of abstraction). On the other hand, the second level of abstraction can also be a lower or the lowest level of abstraction (with regard to the partial order of abstraction). Again, FIG. 2 schematically shows an assignment in which the second level of abstraction lies on a certain level of abstraction. Again, the attribute “second” in “second level of abstraction” does not necessarily denote a second element in the partial order of abstraction and/or refinement. In other words, each level of abstraction of such a partial order may be a second level of abstraction as defined in step 130.

The first specification and/or the second specification can each be a characterization of system behavior (i.e. the behavior of the technical system) over time. The first specification can be an actual specification. The second specification can be a target specification.

The method 100 may comprise checking 140, based on a logical implication (based on the logic 50), how the first specification 10 and the second specification 20 relate to each other. In particular, the method 100 may comprise checking, based on the logical implication=, to what extent 141 (in particular whether or not) the first specification 10 covers the second specification 20 and/or to what extent 142 (in particular whether or not) the second specification 20 covers the first specification 10. For example, in FIG. 1a-d “OK” indicates whether the first specification 10 covers the second specification 20 and “nOK” indicates whether the first specification 10 does not cover the second specification 20 etc.

In other words, the method 100 may comprise checking, based on the logical implication=, to what extent 141 (in particular whether or not) the first specification 10 covers the second specification 20. Alternatively or additionally, the method 100 may comprise checking, based on the logical implication [symbol] , to what extent 142 (in particular whether or not) the second specification 20 covers the first specification 10. Alternatively or additionally, the method 100 may comprise checking, based on the logical implication [symbol] , to what extent 141 (in particular whether or not) the first specification 10 covers the second specification 20 and to what extent 142 (in particular whether or not) the second specification 20 covers the first specification 10.

As already discussed in the context of the more general framework for refinement and/or abstraction, a formal language can comprise or be a set of terms, especially from a syntactic point of view. This set of terms can be subject to one or more rules. This means that only a term that fulfills one or more of these rules is part of the formal language and is therefore a valid term. A formal language can have a semantics that is defined by an interpretation mapping from the formal language into the logic. At least two formal languages (and in particular formal languages of a plurality of formal languages) can each have a semantics, wherein each semantics is defined by a respective (i.e., generally, distinct) interpretation mapping from the respective formal language into logic. This is illustrated schematically in FIG. 3. An evaluation of the interpretation mapping on a term of a formal language can be called an interpretation of the term. Logic can be seen as the basis for describing semantics for every formal language. Thanks to logic, expressions in different formal languages can be related to each other. This makes it possible to check 140 how the first specification 10 and the second specification 20 relate to each other.

A specification A (e.g. the first specification 10) in a formal language (e.g. in the first formal language 11) may cover a specification B (e.g. the second specification 20) in another formal language (e.g. in the second formal language 21, which may be the first formal language) if an interpretation (e.g. I₂(B)) of the specification B implies an interpretation (e.g. I₁(A)) of the specification A, i.e. for example, if I₂(B) [symbol] I₁(A). A and B can be understood here as generic placeholders for terms of the respective formal language. Here, for example, I₁:S₁→L and I₂:S₂→L are the respective interpretation mapping from the first formal language S₁, 10 or second formal language S₁, 20 into the logic L, 50.

For example, the first specification d (the data specification) covers the second specification s (the given specification) if and only if I(s) [symbol] I(d) is the logical implication, wherein [symbol] in this example I=I₁S₁→L is the interpretation mapping from the first formal language S₁ into the logic L. On the other hand, for example, the second specification s covers the first specification d if and only if I(d) [symbol] I(s).

As already discussed in the context of the more general framework, a statement l₁ of logic L can imply the statement l₂ of logic L, i.e. l₁ [symbol] l₂, if the statement l₂ can be formally derived from the statement l₁, e.g. by means of a deduction system consisting of axioms and derivation rules. A statement l₁, l₂ of the logic L can, for example, be formed via an interpretation mapping l, i.e. for example, l₁=I(B), l₂=I(A).

The logical implication=can be based on logic 50 at least to the extent that the logical implication relates statements of logic 50. Method 100 may thus comprise applying the first interpretation mapping 12 to the first specification 10, wherein a first statement of logic 50 results. The method 100 may further comprise applying the second interpretation mapping 22 to the second specification 20, wherein a second statement of logic 50 results. Checking 140, based on logical implication, e.g. how the first specification 10 and the second specification 20 relate to each other, may comprise applying the logical implication to the first statement of logic 50 and the second statement of logic 50, in particular whether and/or to what extent the first statement of logic 50 logically implies (and/or vice versa) the second statement of logic 50.

The first level of abstraction may or may not be the second level of abstraction. In the exemplary FIG. 2 the second level of abstraction is lower (in terms of the partial order of abstraction) than the first level of abstraction. However, the second level of abstraction could also be higher (in terms of the partial order of abstraction) than the first level of abstraction or even on the same level of abstraction, unlike the schematic illustration in FIG. 2.

The first formal language 11 can be the second formal language 21, especially in the case that the first level of abstraction is the second level of abstraction. On the other hand, the first formal language and the second formal language can differ, even if the first level of abstraction is the second level of abstraction.

In the case that the first formal language is the second formal language, the first semantics can also be the second semantics. In this case, the first interpretation mapping is also the second interpretation map. If, on the other hand, the first formal language and the second formal language are different, then the first semantics and the second semantics can (and usually are) different as well. In this case, the first interpretation mapping and the second interpretation mapping are different.

The logic L, 50, i.e. the common logic, may be a temporal logic. In particular, the logic can be a linear temporal logic (also called linear temporal logic) or a signal temporal logic.

Alternatively or additionally, the logic can comprise one or more (decidable) fragments of predicate logic. In particular, the logic may comprise one or more decidable fragments of first-order logic whose decidability can be reduced to a decidable “satisfiability modulo theories” problem, and/or combinations of a temporal logic and at least one such fragment of first-order logic.

It is advantageous if the logic is decidable. On the other hand, it may be possible to carry out procedure 100 at least insofar as expressions of logic are decidable, i.e. if the logical implication (with regard to logic) is decidable.

Translating 120 the time-dependent data 1 into the first specification 10 in the first formal language 11 at the first level of abstraction may comprise, for example, as schematically illustrated in FIG. 1b and FIG. 1d for example: First, translate 121 of the time-dependent data 1 into a third specification 30 in a third formal language 31 on a third level of abstraction, wherein the third formal language 31 has a third semantics, which is defined by a third interpretation mapping 32 from the third formal language 31 into the logic 50. Then translating 122 the third specification 30 into the first specification 10.

The third level of abstraction can, as illustrated schematically in FIG. 2 for example, be the lowest level of abstraction (with regard to the partial order of abstraction) or a lower level of abstraction (with regard to the partial order of abstraction). On the other hand, the third level of abstraction can in turn be any level of abstraction of the partial order of abstraction and/or refinement. Translating 122 the third specification 30 into the first specification 10 can be an abstraction or a refinement, as schematically illustrated in FIG. 2.

The method 100 may comprise a concatenation of a plurality of translation steps (e.g., more than 2, more than 3, more than 4, more than 5, more than 10, more than 50) from the third specification 30 in the third formal language 31 at the third level of abstraction to the first specification 10 in the first formal language 11 at the first level of abstraction. The concatenation can comprise one or more abstractions. Alternatively or additionally, the concatenation can include one or more refinements. For example, the concatenation can include one or more abstractions and one or more refinements. For example, the third specification 30 may first be abstracted to a specification at a level of abstraction higher than the first level of abstraction and then refined to the first specification 10 at the first level of abstraction.

Alternatively or additionally, receiving 130 the second specification 20 in the second formal language 21 at the second level of abstraction may comprise, for example, as schematically illustrated in FIG. 1c and FIG. 1d for example: First receiving 131 a fourth specification 40 in a fourth formal language 41 at a fourth level of abstraction As schematically illustrated in FIG. 1d the method 100 may comprise both translating 122 the third specification 30 into the first specification 10 and translating 132 the fourth specification 40 into the second specification 20.

In the method 100 proposed in this disclosure, two specifications (the first specification 10 and the second specification 20) in the same formal language or in different formal languages can thus be related (e.g. compared) thanks to the common logic), of which at least one specification (namely the first specification 10) was translated 110 from the time-dependent data 1, wherein the two specifications may have been translated from other specifications via the one concatenation and/or the further concatenation.

In the following, one or more possible tests are disclosed which, as illustrated in FIG. 1a-d, for example, can be carried out within the checking 140, but do not have to be.

For example, the method 100 may check 141 whether the first specification 10 (i.e., the data specification d) covers the second specification 20 (i.e., for example, the predetermined specification s). Here you can check whether I₂(s) [symbol] I₁(d) or, if the first language is the second language with the same semantics (I₁=I₂=I), I(s) [symbol] (d). The technical system can then be approved, for example, dependent on the condition that the first specification 10 covers the second specification 20. This condition can therefore be necessary (possibly one of several necessary conditions) for the approval of the technical system. This condition may or may not be sufficient for the technical system to be approved, i.e. if this condition is met, the technical system is approved. If the first specification (i.e. the data specification) covers the second specification, the specification is fully tested with regard to the first level of abstraction by at least one test of the technical system.

Alternatively or additionally, the method 100 may check 142 whether the second specification 20 (i.e., for example, the predetermined specification s) covers the first specification 10 (i.e., the data specification d). Here you can check whether I₁(d) [symbol] I₂(s) or, if the first language is the second language with the same semantics (I₁=₂=I), I(d) [symbol] I(s). Again, the technical [symbol] system can be approved dependent on this, in particular assuming that the second specification 20 covers the first specification 10. This condition can therefore also be necessary (possibly one of several necessary conditions) for the approval of the technical system. This condition may or may not be sufficient for the technical system to be approved, i.e. if this condition is met, the technical system is approved. If the second specification covers the first specification, the technical system behaves in accordance with the specification as far as at least one test of the technical system is concerned.

The approval of the technical system may require that both the second specification covers the first specification and the first specification covers the second specification. In this case, procedure 100 comprises both checks. These conditions may or may not be sufficient.

Alternatively or additionally, the method 100 may check 143, based on the logical implication [symbol] , whether a first portion of the first specification 10 (i.e., the data specification d) exceeds the second specification 20 (i.e., for example, the predetermined specification s). In particular, as illustrated schematically in FIG. 1a-d for example, this check can be carried out in the event that the first specification 10 covers the second specification 20 and/or in the event that the second specification 20 does not cover the first specification 10. On the other hand, the method 100 may comprise, other than as schematically illustrated in FIG. 1a-d checking 143 whether a first part of the first specification exceeds the second specification, as an alternative to checking to what extent the first specification covers the second specification 141 and/or to what extent the second specification covers the first specification 142.

If such a first part exists, the method 100 may comprise extending the second specification 20 by an intersection of the first specification 10 and a negated second specification, in formulae e.g. I₁(d)∧¬I₂(s) or, if I₁=I₂=I,I(d)∧¬I(s), wherein ¬, represents the negation and A represents an and in the logic L, 50. The method 100 may comprise translating the extended specification, i.e. the second specification 20 combined with this extension, into another level of abstraction. This translation can take place through abstraction and/or refinement.

The method 100 may include checking whether the second specification may be extended by the intersection. In particular, the method 100 may make the extension of the second specification dependent on a consent of a user of the method 100 (e.g. via a user interface). It is conceivable, for example, that an extension of the second specification is deliberately excluded.

Alternatively or additionally, particularly in the event that the second specification does not cover the first specification, it can be checked whether there is an error in the technical system, whether the second specification (or the fourth specification) is faulty and/or whether there is an apparent inconsistency due to the translation (particularly due to the abstraction) of the time-dependent data from the at least one test of the technical system.

Alternatively or additionally, the method 100 may check 144, based on the logical implication=, whether a second portion of the second specification 20 (i.e., for example, the predetermined specification s) exceeds the first specification 10 (i.e., the data specification d). In particular, as illustrated schematically in FIG. 1a-d for example, this check can be carried out in the event that the second specification covers the first specification and/or in the event that the first specification does not cover the second specification. The method 100 may, on the other hand, other than as schematically illustrated in FIGS. 1a-d comprise checking 144 whether a second part of the second specification is more specific than the first specification, as an alternative to testing whether the first specification covers 141 the second specification and/or whether the second specification covers 142 the first specification.

If such a second part exists, the method 100 may comprise extending the first specification by an intersection of the second specification 20 and a negated first specification, in formulae e.g. I₂(s)∧¬I₁(d) or, if I₁=I₂=I, I(s)∧¬I(d), wherein ¬ represents the negation and A represents an and in the logic L, 50. The method 100 may then, but need not, comprise translating the extended data specification, i.e. the first specification 10 combined with this extension, into another level of abstraction. This translation can take place through abstraction and/or refinement. The method may further comprise generating at least one further test of the technical system based on the extended data specification, in particular based on a refinement of this second part.

At least one further test of the technical system can now be carried out, resulting in further time-dependent data. The method 100 may comprise performing the at least one further test. The resulting additional time-dependent data can, for example, be combined with the time-dependent data 1. Procedure 100 can then be carried out again. Alternatively, the method 100 can be executed only on the further time-dependent data (as time-dependent data 1 of the new execution of the method 100).

Alternatively or additionally, the method 100 can be continued as follows:

The method 100 may comprise receiving further time-dependent data (e.g. measurement and/or simulation data) from the at least one further test of the technical system.

The method 100 may further comprise translating the further time-dependent data into a further first specification in the first formal language at the first level of abstraction. This can be done via at least one abstraction, for example.

The method 100 may further comprise defining a further second specification in the second formal language at the second level of abstraction based on the further first specification.

Furthermore, an iterative procedure is revealed for automatically translating one or more specifications into at least one test of the technical system and for determining a coverage of a specification from the result of one or more tests of the technical system in the form of time-dependent data 1 (measurement and/or simulation data). This can be repeated until the specification is covered by one or more tests. Consider
s∈S_{J} a specification in the formal language Sⱼ that is to be covered by one or more tests of the technical system,
sel:Sⱼ×L→Sⱼ a function that returns a partial specification so that ∀s∈Sⱼ, l∈L:I(sel(s,l)) [symbol] I(s)∧l, I(s)∧l [symbol] I(sel(s,l)),
S [symbol] . . . [symbol] Sₖ a sequence of refinements of Sⱼ into a formal language Sₖ close to L in the partial order (i.e. close to or at the lowest level of abstraction),
S [symbol] . . . [symbol] Sₖ a sequence of abstractions from Sₖ to Sⱼ,
s2e:Sₖ→E a function that converts a specification s′∈Sₖ into at least one test of the technical system, e.g. by selecting parameters that are consistent with I(s′),
d2s:D→Sₖ a function that converts the result of at least one test of the technical system in the form of time-dependent data (e.g. measurement data) d∈D into a specification s′∈Sₖ.

The iterative process can be represented by the following algorithm, for example:

K := false
while not I(s) [symbol] K
- s′ := sel(s, ¬K)
- s′ [symbol] ... [symbol] s″

Consider d the time-dependent data 1 (e.g. the measurement data) of at least one test of the technical system, s2e(s″)
s′″:=d2s(d)
s″″ [symbol] . . . [symbol] s′″
if not I(s″″) [symbol] I(s): At least one test of the technical system violates the specification s or the abstraction is too imprecise. In this case, the method ends.

$$K : = K ⋁ I ( {s}^{′′′′} )$$

In particular, this algorithm comprises receiving 130 a second specification 20 (namely s) in a second formal language 21 at a second level of abstraction at the latest in the step “while not I(s) [symbol] K”.

Furthermore, in the step “Consider d “the time-dependent data 1 . . . ”, this algorithm comprises receiving 110 time-dependent data 1 (namely d) from at least one test of the technical system.

Furthermore, in steps “s′″:=d2s(d)” and “s″″ [symbol] . . . [symbol] s′″”, this algorithm comprises translating 120 the time-dependent data 1 (namely d) into a first specification 10 (namely s″″) in a first formal language 11 at a first level of abstraction.

Furthermore, in the step “if not I(s″″) [symbol] I(s)”, this algorithm comprises checking 140, based on a logical implication [symbol] , how the first specification 10 (namely s″″) and the second specification 20 (namely s) relate to each other. In particular, based on the logical implication [symbol] it is checked here to what extent (or more precisely whether) 142 the second specification 20 (namely s) covers the first specification 10 (namely s″″).

In this exemplary algorithm, the first specification 10 and the second specification 20 are defined in the same formal language, which is why both can be mapped into the logic 50 using the same interpretation mapping I. The iterative algorithm can also be adapted in such a way that the first specification 10 and the second specification 20 are defined in different formal languages. The individual interpretation mapping (i.e. I₁(s″″)) and I₂(s))) must then be used here.

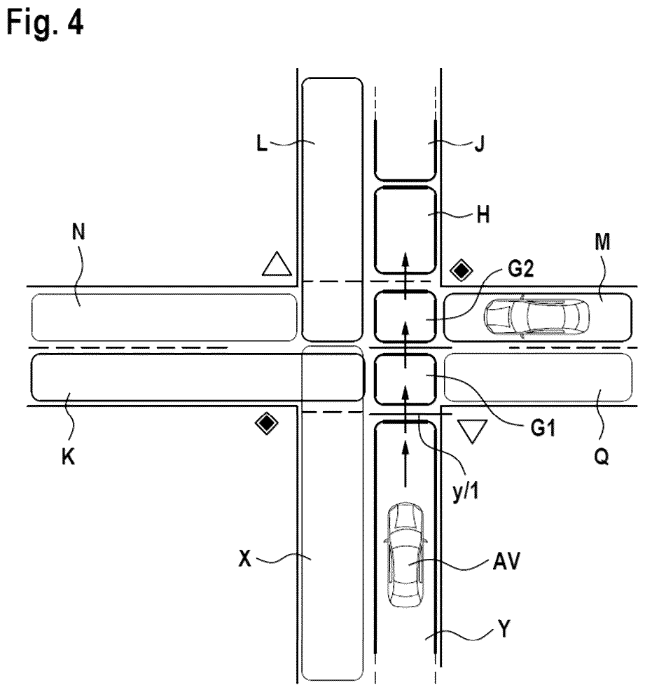

The following example illustrates an application of the method 100 in the context of an at least partially autonomously driving vehicle. The aim of the specifications in this example can be the formalization of the driving behavior of an at least partially autonomously driving vehicle (ego vehicle or AV) in an intersection situation with another road user (subject) as schematically illustrated in FIG. 4. Part of the intersection forms a zone G2 in which the ego vehicle and subject can be present at the same time, although this should be avoided. The driving intention of the ego vehicle can, for example, be a movement along the zone sequence Y, G1, G2, H, J. The subject's travel intention can be, for example, a movement along the zone sequence M, G2, L, N.

Consequently, the technical system here is the at least partially autonomously driving (ego) vehicle. For this application, the logic 50 can be defined as follows as an example: The logic 50 can be a linear temporal logic.

The logic 50 may comprise the following propositional atoms: OverlapEgoZoneZ for an overlap of the (ego) vehicle with a zone Z, for each zone Z from a set of zones Y, G1, G2, H, J in which the (ego) vehicle can move. These propositional atoms can be referred to as UeEZ=ÜberschneidungEgoZoneZ, Z E {G1, G2, H, J, K, L, M, N, Q, Y} below.

Alternatively or additionally, the logic 50 may comprise the following propositional atoms: OverlapEgoZoneZ for an overlap of a further road user with the zone Z, per zone Z from the set of zones M, G2, L, N in which the further road user can move. These propositional atoms can be referred to as UeSZ=ÜberschneidungSubjektZoneZ, Z E {G1, G2, H, J, K, L, M, N, Q, Y} below.

Alternatively or additionally, the logic 50 may comprise the following propositional atoms: PredictedOverlapEgoSubject_k for a predicted overlap of the (ego) vehicle with the other road user at a time step k of a prediction horizon, per k from a set of time steps of the prediction horizon. These propositional atoms can be referred to as PUeESₖ=PrädizierteÜberschneidungEgoSubjektₖ,1≤k≤N below.

Alternatively or additionally, the logic 50 may comprise the following propositional atoms: PredictedOverlapEgoZoneZ_k for a predicted overlap of the (ego) vehicle with zone Z at a time step k of the prediction horizon, for each zone Z from the set of zones, and for each k from the set of time steps of the prediction horizon. These propositional atoms can be referred to as PUeEZₖ=PrädizierteÜberschneidungEgoZoneZₖ,1≤k≤N, Z∈{G1, G2, H, J, K, L, M, N, Q, Y} below.

Alternatively or additionally, the logic 50 may comprise the following propositional atoms: PredictedOverlapSubjectZoneZ_k for a predicted overlap of a further road user with zone Z at a time step k of the prediction horizon, for each zone Z from the set of zones, and for each k from the set of time steps of the prediction horizon. These propositional atoms can be referred to as PUeSZₖ=PrädizierteÜberschneidungSubjektZoneZₖ,1≤k≤N, Z∈{G1, G2, H, J, K, L, M, N, Q, Y} below.

In particular, logic 50 can use the above-mentioned propositional atoms
OverlapEgoZoneZ,
OverlapSubjectZoneZ,
PredictedOverlapEgoSubject_k,
PredictedOverlapEgoZoneZ_k, and
PredictedOverlapSubjectZoneZ_k comprise (each for all zones Z and discrete prediction timing k).

The propositional atoms themselves can also be evaluated discretely in time using linear temporal logic over real time.

For example, a propositional atom (or each of these propositional atoms) can have a value range with two values. In particular, a propositional atom (or each of these propositional atoms) can be Boolean (e.g. with value range “false”, “true” or 0, 1 . . . ). Alternatively, a propositional atom (or each of these propositional atoms) can be a quantitative measure, in particular a quantitative measure of a degree of fulfillment. For example, a propositional atom (or each of these propositional atoms) may take negative values (and e.g. zero) for “false” and positive values for “true”. Each propositional atom is an element of logic 50.

In this example, reference is made to a prediction of the behavior of all road users relevant to the traffic situation within the (ego) vehicle. The dynamics can be treated discretely in time and the prediction horizon can have the length (number of time steps into the future) in each time step, for example. There can therefore be two time dimensions here: the real (discrete) time and the (discrete) prediction time at each real time point.

The propositional atoms can now be divided into two groups: The following propositional atoms can only refer to real (discrete) time: OberschneidungEgoZoneZ, Z∈{G1, G2, H, J, K, L, M, N, Q, Y} and ÜberschneidungSubjektZoneZ. In contrast, the following propositional atoms can also refer to the (discrete) prediction time in addition to the real (discrete) time: PrädizierteÜberschneidungEgoSubjektₖ, PrädizierteÜberschneidungEgoZoneZₖ and PrädizierteÜberschneidungSubjektZoneZₖ.

For example, the propositional atoms can be determined from measurement data as follows:
1. In a fixed (x,y) coordinate system, the Z∈{G1, G2, H, J, K, L, M, N, Q, Y}zones on the concrete geometry (map) can be described as polygons. The position of the autonomous (ego) vehicle (AV) and the other subjects can be measured in this coordinate system at discrete points in time tₖ and designated as (x_{ego}(tₖ),y_{ego}(tₖ)) and (x_{subj}(tₖ),y_{subj}(tₖ)) respectively. This allows the first two propositional atoms, which only refer to real time, to be calculated:

ÜOberschneidungEgoZoneZ: (x_{ego}(tₖ),y_{ego}(tₖ))∩Z≠Ø

ÜberschneidungSubjektZoneZ: (x_{sub}j(tₖ),y_{subj}(tₖ))∩Z≠Ø
wherein Ø is the empty set and n is a cut operator of logic 50.
2. The other atoms require a prediction of all permissible behavior of the vehicles (AV, subjects) for each discrete real time tₖ over a defined prediction horizon in discrete time steps t_{p,j}, 1≤j≤N. This prediction can take place in the (ego) vehicle (AV). It can either be measured at the same time or it must then be determined from the existing measurement data (i.e. the time-dependent data 1). The permitted behavior can be described using a simple dynamics model in a local (s,t)—coordinate system. It can be assumed that the t coordinate (here not a temporal constant, but a spatial coordinate transverse to the direction of movement) remains constant and the movement only takes place along the s coordinate:

$$v ( t ) = {\int }_{τ = 0}^{t} a ( t ) dt , s ( t ) = {\int }_{τ = 0}^{t} v ( t ) d τ$$

It can also be assumed that the acceleration lies in an interval aₘᵢₙ≤a(t)≤aₘₐₓ. On the one hand, it can be assumed that the speed does not become negative (i.e. it can be assumed that the vehicles do not reverse). On the other hand, it can be assumed that the vehicles adhere to the maximum permitted speed vₘₐₓ. This results in the predicted position s at each discrete prediction time t_{p,j} as an interval sₘᵢₙ(t_{p,j})≤s(t_{p,j})≤sₘₐₓ(t_{p,j}) with

$${s}_{min} ( {t}_{p , j} ) = \{ \begin{matrix}{s}_{0} + {v}_{0} {t}_{p , j} + \frac{1}{2} {a}_{min} {t}_{p , j}^{2} , ( {a}_{min} = 0 ) ⋁ ( {a}_{min} < 0 ⋀ {t}_{p , j} \leq − \frac{{v}_{0}}{{a}_{min}} ) ⋁ ( {a}_{min} > 0 ⋀ {t}_{p , j} \leq \frac{{v}_{max} − {v}_{0}}{{a}_{min}} ) \\ {s}_{0} − \frac{{v}_{0}^{2}}{2 {a}_{min}} , {a}_{min} < 0 ⋀ {t}_{p , j} > − \frac{{v}_{0}}{{a}_{m in}} \\ {s}_{0} + {v}_{max} {t}_{p , j} − \frac{{( {v}_{max} − {v}_{0} )}^{2}}{2 {a}_{min}} , {a}_{min} > 0 ⋀ {t}_{p , j} > \frac{{v}_{max} − {v}_{0}}{{a}_{min}}\end{matrix}$$

$${s}_{max} ( {t}_{p , j} ) = \{ \begin{matrix}{s}_{0} + {v}_{0} {t}_{p , j} + \frac{1}{2} {a}_{max} {t}_{p , j}^{2} , ( {a}_{max} = 0 ) ⋁ ( {a}_{u b} < 0 ⋀ {t}_{p , j} \leq − \frac{{v}_{0}}{{a}_{u b}} ) ⋁ ( {a}_{max} > 0 ⋀ {t}_{p , j} \leq \frac{{v}_{max} − {v}_{0}}{{a}_{max}} ) \\ {s}_{0} − \frac{{v}_{0}^{2}}{2 {a}_{max}} , {a}_{max} < 0 ∧ {t}_{p , j} > − \frac{{v}_{0}}{{a}_{max}} \\ {s}_{0} + {v}_{max} {t}_{p , j} − \frac{{( {v}_{max} − {v}_{0} )}^{2}}{2 {a}_{max}} , {a}_{max} > 0 ∧ {t}_{p , j} > \frac{{v}_{max} − {v}_{0}}{{a}_{max}}\end{matrix}$$

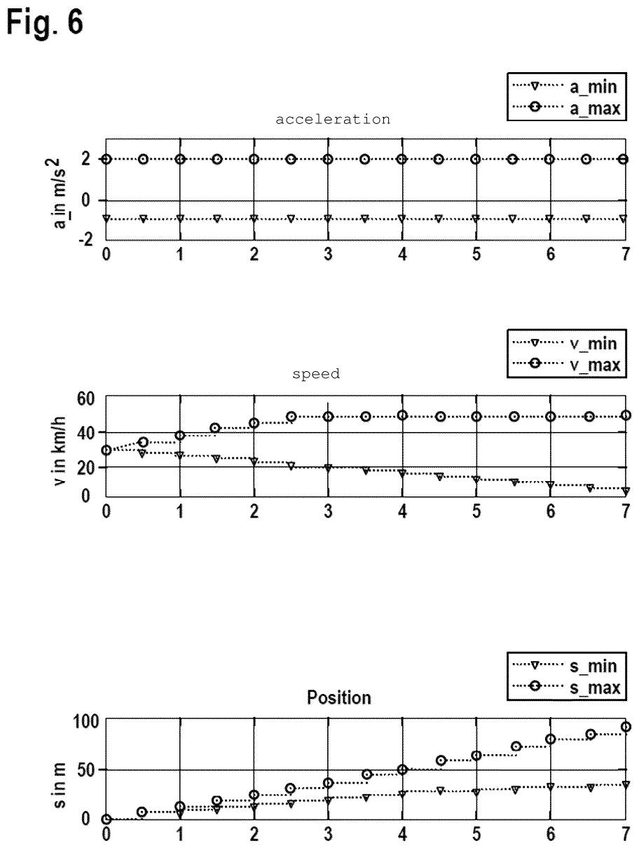

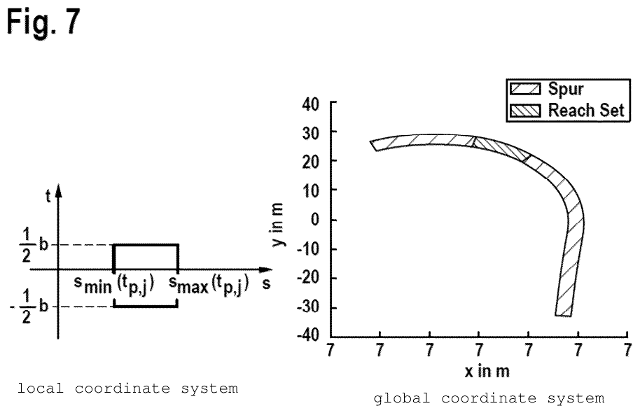

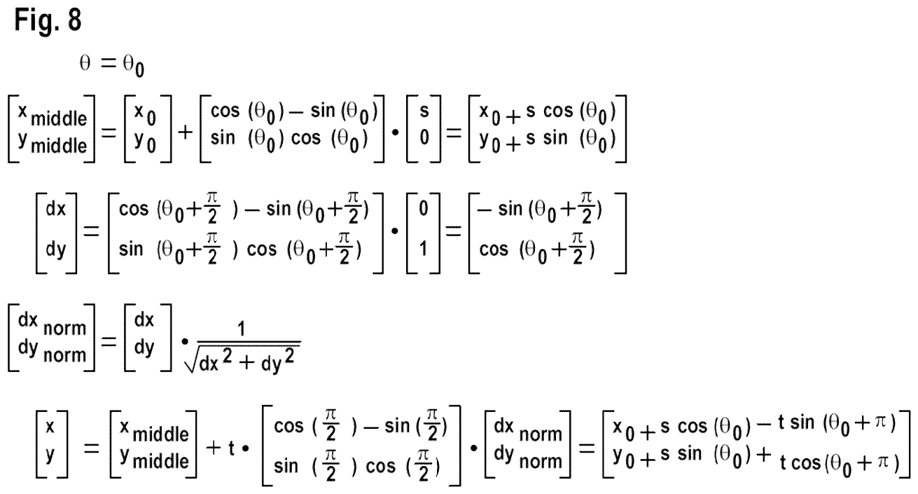

FIG. 6 shows examples of acceleration, speed and position intervals over the prediction time. The calculation can be performed for any discrete real time tₖ. Accordingly, v₀ can denote the measured speed and s₀ the measured position at a discrete real time tₖ in the local coordinate system.
3. The calculated position intervals in the local coordinate system can be transformed into the global coordinate system. For this purpose, it can be assumed that the vehicles move along a road or lane on this road, which can be described in the local (s,t) coordinate system. The t coordinate can be assumed to be constant and extended to the entire track width. The road types can be defined according to the ASAM OpenDrive standard, for example. For the simplest road type, a straight road, FIG. 8 shows an exemplary transformation from the local to the global coordinate system. The transformation of the local position intervals expressed in the scoordinate and extended to the complete track width (t=±b/2) can result in a polygon in the global coordinate system, which can be described as RS (Reach Set), see for example FIG. 7. Z can denote a zone in the global coordinate system described as a polygon.
The reach sets for each prediction time RS(tₖ) can now be used to calculate the propositional atoms accordingly:

$$Pr \ddot{a} dizierte \ddot{U} {berschneidungEgoSubjekt}_{k} = TRUE ⇔ {RS}_{e g o} ( {t}_{k} ) ∩ {RS}_{subj} ( {t}_{k} ) \neq ∅$$

$$Pr \ddot{a} dizierte \ddot{U} {berschneidungEgoZone}_{k} = TRUE ⇔ {RS}_{e g o} ( {t}_{k} ) ∩ Z \neq ∅$$

$$Pr \ddot{a} dizierte \ddot{U} {berschneidungSubjektZone}_{k} = TRUE ⇔ {RS}_{subj} ( {t}_{k} ) ∩ Z \neq ∅$$

In the context of this example, three exemplary formal languages are now revealed. Let the languages S₁, S₂, S₃ in this example be defined syntactically as follows and in Backus-Naur form:

The first formal language S₁, which may be, but need not be, the first formal language 11 in the method 100, may be defined, for example, as follows:

$${S}_{1} ∷ = Pr \ddot{a} dizierteKollisionEgoSubjekt ( k ) \vert EgoInZoneY ( k ) \vert SubjektInZoneM ( k ) \vert$$

$$Pr \ddot{a} diziertEgoSubjektInZoneG 1 G 2 ( k ) {\vert {S}_{1} ⋀ {S}_{1} \vert {S}_{1} ⋁ {S}_{1}^{′} \vert}_{¬} {S}_{1} , k ∈ ℕ$$

An exemplary simple specification in the first formal language S₁ can be, for example:

$$¬ P r \ddot{a} dizierteKollisionEgoSubjekt ( k ) , f \ddot{u} r alle k ∈ ℕ$$

whereby this specification results from the fact that these terms should be 1 (true). This means that a collision can be avoided in good time.

The second formal language S₂, which may be, but need not be, the second formal language 21 in the method 100, may for example be defined as follows, where the comma leads to a tuple formation:

| | S₂ ::= S₂^{a}, S₂^{a′}, ... | | |
|---|---|---|---|
| Wherein | | | |
| | S₂^{a} ::= (S₂^{b}, S₂^{b′}, ... ) | | |
| and again | | | |
| S₂^{b} ::= PrädizierteKollisionEgoSubjekt \| P̅r̅ä̅d̅i̅z̅i̅e̅r̅t̅e̅K̅o̅l̅l̅i̅s̅i̅o̅n̅E̅g̅o̅S̅u̅b̅j̅e̅k̅t̅ \| | | | |
| - EgoInZoneY | \| | E̅g̅o̅I̅n̅Z̅o̅n̅e̅Y̅ | \| |
| SubjektInZoneM | \| | S̅u̅b̅j̅e̅k̅t̅I̅n̅Z̅o̅n̅e̅M̅ | \| |
| PrädiziertEgoSubjektInZoneG2 | \| | P̅r̅ä̅d̅i̅z̅i̅e̅r̅t̅E̅g̅o̅S̅u̅b̅j̅e̅k̅t̅I̅n̅Z̅o̅n̅e̅G̅2̅ | \| |

S₂^{b} ∧ S₂^{b′}

For example, the third formal language S₃, which may or may not be the third formal language 31 in the procedure 100, can be defined as follows:

S₃::=S₂
In this example, the second formal language S₂ and the third formal language S₃ can therefore be syntactically identical. However, they will differ in their semantics.

The exemplary formal language S₁ can syntactically correspond to a propositional logic, whereby the index k of the atoms can imply an order in real time. For example, EgoInZoneY(1)∧¬EgoInZoneY(2) can intuitively mean that the (ego) vehicle is in zone Y at one time and no longer there at a later time. The meaning of S₁ in L can be formalized as follows. Given a term s∈S₁, this can be converted into a disjunctive normal form s₁∨s₂∨ . . . , whereby sᵢ can be a conjunction of positive or negated propositional atoms PradizierteKollisionEgoSubjekt(k), EgoInZoneY(k), SubjektInZoneM(k), PradiziertEgoSubjektInZoneG1G2(k). Consider s_{i,k} a conjunction consisting of the propositional atoms in sᵢ with index k. The interpretation mapping I₁ of s into L can thus be given by the following formula:

$$◇ ( {s}_{1 , 1} ⋀ ◇ ( {s}_{1 , 2} ◇ … ) ) ⋁ ◇ ( {s}_{2 , 1} ⋀ ◇ ( {s}_{2 , 2} ∧ … ) ) ⋁ …$$

wherein the following substitution can be defined for the propositional atoms in s_{i,k}:

$$P r \ddot{a} dizierteKollisionEgoSubjekt ( k ) \to {⋁}_{1 \leq {k}^{′} \leq N} PUeE {S}_{{k}^{′}}$$

$$EgoInZoneY ( k ) \to UeEY$$

$$SubjektInZoneM ( k ) \to UeSM$$

$$Pr \ddot{a} diziertEgoSubjektInZoneG 1 G 2 ( k ) \to {⋁}_{1 \leq {k}^{′} \leq N} ( ( PUeEG {1}_{{k}^{′}} ⋁ PUeEG {2}_{{k}^{′}} ) ⋀ ( PUeSG {1}_{{k}^{′}} ⋁ PUeSG {2}_{{k}^{′}} ) )$$

The LTL formula can be understood as a set of sequences of abstract situations, wherein ⋄(s_{1,1}∧⋄(s_{1,2}∧ . . . )) can mean that s_{1,1} is fulfilled at a real point in time and s_{1,2} at a later point in time and so on. Thereby s_{i,k} can be a propositional formula consisting of the propositional atoms of L. The index k in the language elements of S₁ can denote an abstract real time, whereas the index k′ in the interpretation can refer to a prediction time. In the LTL formula, there are no indices here that refer to real time, as these references can be expressed by the temporal operators U (Until), ⋄ (Eventually) and □ (Always). Only the references to the prediction time can be coded using indices.

The languages S₂ and S₃ can be syntactically identical. An element (s_{1,1}, s_{1,2}, . . . ), (s_{2,1}, s_{2,2}, . . . ), . . . of the languages can describe a set of tuples (sequences) of conjunctions of propositional atoms, which can appear positive (e.g. EgoInZoneY) or negated (e.g. E̅g̅o̅I̅n̅Z̅o̅n̅e̅Y̅).

The interpretation mapping I₂ of S₂ into L can be given by the following formula:

$$◇ ( {s}_{1 , 1} ⋀ ◇ ( {s}_{1 , 2} ◇ … ) ) ⋁ ◇ ( {s}_{2 , 1} ⋀ ◇ ( {s}_{2 , 2} ∧ … ) ) ⋁ …$$

wherein the propositional atoms can be defined in s_{i,k} the following replacement:

$$P r \ddot{a} dizierteKollisionEgoSubjekt ( k ) \to {⋁}_{1 \leq {k}^{′} \leq N} PUeE {S}_{{k}^{′}}$$

$$P r \ddot{a} dizierteKollisionEgoSubjekt ( k ) \to ¬ {⋁}_{1 \leq {k}^{′} \leq N} PUeE {S}_{{k}^{′}}$$

$$EgoInZoneY ( k ) \to UeEy$$

$$\overline{EgoInZoneY ( k )} \to ¬ UeEy$$

$$SubjektInZoneM ( k ) \to UeSM$$

$$\overline{SubjektInZoneM ( k )} \to ¬ UeSM$$

$$Pr \ddot{a} diziertEgoSubjektInZoneG 2 ( k ) \to {⋁}_{1 \leq {k}^{′} \leq N} ( ( PUeEG {2}_{{k}^{′}} ⋀ PUeSG {2}_{{k}^{′}} )$$

$$\overline{Pr \ddot{a} diziertEgoSubjektInZoneG 2 ( k )} \to ¬ {⋁}_{1 \leq {k}^{′} \leq N} ( ( PUeEG {2}_{{k}^{′}} ⋀ PUeSG {2}_{{k}^{′}} )$$

The index k is the position of s_{i,k} in the tuple.
The interpretation mapping I₃ of S₃ into L can be given by the following formula:

$${s}_{1 , 1} U ( {s}_{1 , 2} U … U {s}_{1 , {m}_{1}} ) ⋁ {s}_{2 , 1} U ( {s}_{2 , 2} U … U {s}_{2 , {m}_{2}} ) ⋁ …$$

wherein the same replacement as for S₂ applies to the propositional atoms s_{i,k}. Intuitively, I₂ can mean that every s_{i,k} in the specified sequence must be true at some point. Conversely, for I₃ it can be required that each s_{i,k} must be valid until the next element s_{i,k+1} becomes true. In particular, there can therefore be no point in time at which no s_{i,k} is fulfilled. This is quite possible in the case of I₂.

If, for example, the refinement R_{2,3} and the abstraction A_{3,2} are given by the identity, then S₂ [symbol] S₃ and S₂ [symbol] S₃apply, hence ∀s∈S₃:I₃(s) [symbol] I₂(s). The refinement R_{1,2} can be defined by transforming s∈S₁ into the disjunctive normal form, whereby the sets of tuples result from the disjunction and the tuples themselves from the conjunction. The reverse direction results in the abstraction A_{2,1}. It should be noted that PradiziertEgoSubjektInZoneG1G2(k) is refined after PradiziertEgoSubjektInZoneG2 and all conjunctions in which ¬PrädiziertEgoSubjektInZoneG1G2(k) is deleted because I₂ (PrädiziertEgoSubjektInZoneG2) [symbol] I₁(PrädiziertEgoSubjektInZoneG1G2(k)), but I₂(¬PrädiziertEgoSubjektInZoneG2) [symbol] I₁(¬PradiziertEgoSubjektInZoneG1G2(k)). For this reason, PradiziertEgoSubjektInZoneG2 is abstracted to PrädiziertEgoSubjektInZoneG1G2(k) with the corresponding k and P̅r̅ä̅d̅i̅z̅i̅e̅r̅t̅E̅g̅o̅S̅u̅b̅j̅e̅k̅t̅I̅n̅Z̅o̅n̅e̅G̅2̅ is deleted in the abstraction. This means that S₁ [symbol] S₂ [symbol] S₃ and S₁ [symbol] S₂ [symbol] S₃apply in this example.

Another exemplary specification in the first formal language S₁ can be given as follows:
EgoInZoneY(1) A SubjektInZoneM(1) A PradiziertEgoSubjektInZoneG1G2(1) ∧¬PrädizierteKollisionEgoSubjekt(1)∧EgoInZoneY(2) ∧SubjektInZoneM(2)∧PrädizierteKollisionEgoSubjekt(2)
The refinement of this specification to S₂ or S₃ has the following form here:
(EgoInZoneY∧SubjektInZoneM∧PrädiziertEgoSubjektInZoneG2 ∧P̅r̅ä̅d̅i̅z̅i̅e̅r̅t̅e̅K̅o̅l̅l̅i̅s̅i̅o̅n̅E̅g̅o̅S̅u̅b̅j̅e̅k̅t̅, EgoInZoneY∧SubjektInZoneM∧PrädizierteKollisionEgoSubjekt)

Alternatively or additionally, a computer-implemented method 200 for manufacturing a specification-compliant technical system, in particular a specification-compliant at least partially autonomous driving vehicle or a part thereof.

The method 200 may comprise receiving 210 an initial specification 10 in an initial formal language 11 at an initial level of abstraction, wherein the initial formal language 11 has an initial semantics defined by an initial interpretation mapping 12 from the initial formal language 11 into a logic 50, preferably wherein the logic 50 is decidable.

The method 200 may further comprise receiving 130 a second specification 20 in a second formal language 21 at a second level of abstraction, wherein the second formal language 21 has a second semantics defined by a second interpretation mapping 22 from the second formal language 21 into the logic 50.

The method 200 may further comprise checking 240, based on a logical implication=(based on the logic 50), how the first specification 10 and the second specification 20 relate to each other, in particular checking, based on the logical implication=, to what extent 241 (in particular whether or not) the first specification 10 covers the second specification 20 and/or to what extent 242 (in particular whether or not) the second specification 20 covers the first specification 10.

The method 200 may be the method 100 in any of the embodiments disclosed herein, except that in the method 200, the first specification is not necessarily translated 120 from time-dependent data 1. In other words, the step 110 in the method 100 may be dispensable and step 120 may be adapted to receive the first specification 10 in the first formal language 11 at the first level of abstraction 210.

A computer system is also disclosed that is designed to execute the computer-implemented method 100 for manufacturing a specification-compliant technical system, in particular a specification-compliant at least partially autonomous driving vehicle or a part thereof, comprising: The computer system can comprise a processor and/or a working memory.

A computer program is also disclosed that is designed to execute the computer-implemented method 100 for manufacturing a specification-compliant technical system, in particular a specification-compliant at least partially autonomous driving vehicle or a part thereof, comprising: The computer program may, for example, be present in interpretable or compiled form. For execution, it may be loaded (also in portions) into the RAM of a computer, for example, as a bit or byte sequence.

Furthermore disclosed is a computer-readable medium or signal, which stores and/or contains the computer program. The medium may, for example, comprise one of RAM, ROM, EPROM, HDD, SDD, . . . on/in which the signal is stored.

What is claimed is:

1. A computer-implemented method for producing a specification-compliant technical system, comprising:
receiving time-dependent data from at least one test of the technical system;
translating the time-dependent data into a first specification in a first formal language at a first level of abstraction, wherein the first formal language has a first semantics defined by a first interpretation mapping from the first formal language into a logic;
receiving a second specification in a second formal language at a second level of abstraction, wherein the second formal language has a second semantics defined by a second interpretation mapping from the second formal language into the logic; and
checking, based on a logical implication, how the first specification and the second specification relate to each other, by checking, based on the logical implication, to what extent the first specification covers the second specification and/or to what extent the second specification covers the first specification.

2. The method according to claim 1, wherein:
the first level of abstraction is the second level of abstraction, and
the first formal language is the second formal language.

3. The method according to claim 1, wherein the logic is a linear temporal logic or a signal temporal logic.

4. The method according to claim 1, wherein translating the time-dependent data into the first specification in the first formal language at the first level of abstraction comprises:
translating the time-dependent data into a third specification in a third formal language at a third level of abstraction, wherein the third formal language has a third semantics defined by a third interpretation mapping from the third formal language into the logic; and
translating the third specification into the first specification.

5. The method according to claim 4, wherein translating of the third specification into the first specification is an abstraction or a refinement.

6. The method according to claim 1, wherein receiving the second specification in the second formal language at the second level of abstraction comprises:
receiving a fourth specification in a fourth formal language at a fourth level of abstraction, wherein the fourth formal language has a fourth semantics defined by a fourth interpretation mapping from the fourth formal language into the logic; and
translating the fourth specification into the second specification.

7. The method according to claim 6, wherein translating of the fourth specification into the second specification is an abstraction or a refinement.

8. The method according to claim 1, further comprising:
checking whether the first specification covers the second specification,
wherein an approval of the technical system requires that the first specification covers the second specification.

9. The method according to claim 1, further comprising:
checking whether the second specification covers the first specification,
wherein an approval of the technical system requires that the second specification covers the first specification.

10. The method according to claim 1, further comprising:
based on the logical implication, checking whether a first part of the first specification goes beyond the second specification; and
when such a first part exists, extending the second specification by an intersection of the first specification and a negated second specification.

11. The method according to claim 1, further comprising:
based on the logical implication, checking whether a second part of the second specification goes beyond the first specification; and
when such a second part exists, generating at least one further test of the technical system based on a refinement of this second part.

12. The method according to claim 11, further comprising:
receiving further time-dependent data from at least one further test of the technical system;
translating the further time-dependent data into a further first specification in the first formal language at the first level of abstraction via abstraction; and
defining a further second specification in the second formal language at the second level of abstraction based on the further first specification.

13. The method according to claim 1, wherein:
the technical system is an at least partially autonomously driving vehicle, and
the logic is a linear temporal logic comprising a plurality of propositional atoms including:
OverlapEgoZoneZ for an overlap of the vehicle with a zone Z, for each zone Z from a set of zones in which the vehicle can move,
OverlapEgoZoneZ for an overlap of a further road user with a zone Z, for each zone Z from a set of zones in which the road user can move,
PredictedOverlapEgoSubject_k for a predicted overlap of the vehicle with the other road user at a time step k of a prediction horizon, per k from a set of time steps of the prediction horizon,
PredictedOverlapEgoZoneZ_k for a predicted overlap of the vehicle with zone Z at a time step k of the prediction horizon, for each zone Z from the set of zones, and for each k from the set of time steps of the prediction horizon, and
PredictedOverlapSubjectZoneZ_k for a predicted overlap of a further road user with zone Z at a time step k of the prediction horizon, for each zone Z from the set of zones, and for each k from the set of time steps of the prediction horizon.

14. The method according to claim 1, wherein a computer program is configured to execute the computer-implemented method.

15. A non-transitory computer-readable medium or signal that stores and/or contains the computer program of claim 14.

16. A computer system configured to execute the method of claim 1 for manufacturing the specification-compliant technical system.
